(19) United States
(12) Patent Application Publication
(10) Pub. No.: US 2014/0098185 A1
(43) Pub. Date: Apr. 10, 2014

(54) Interactive user selected video/audio views by real time stitching and selective delivery of multiple video/audio sources

(71) Applicants: Shahram Davari, Los Altos, CA (US); Behnam Salemi, San Diego, CA (US)

(72) Inventors: Shahram Davari, Los Altos, CA (US); Behnam Salemi, San Diego, CA (US)

(21) Appl. No.: 13/573,820

(22) Filed: Oct. 9, 2012

(51) Int. Cl. H04N 7/00

(52) U.S. Cl. CPC H04N 7/00
USPC 348/36; 348/E07.001

(57) ABSTRACT

This invention describes how a panoramic view can be created in real-time using multiple ordinary video cameras by splicing the video frames in real-time. It also describes how a subset of that panoramic view can be viewed on customer screen and how a customer can smoothly shift and scroll or zoom the customer view in real-time to view the other parts of the panoramic view using a remote control device. This invention also describes how all this can be achieved economically by using a cloud service such as assigning a Virtual Machine to each customer and using hardware acceleration engines in the data center such as high-end video cards.

### BACKGROUND OF THE INVENTION

During live events, such as live sports events, live concerts, live news reports, surveillance, etc. usually there are multiple Cameras that capture, transmit and record Audio/Video (A/V) streams. However at any point in time only one of the A/V streams associated with just one of the cameras can be viewed by an audience (end user). In some cases such as sports events, concerts and live reports the audience has no control over which camera to watch, since the TV director decides which camera is broadcasted at any point in time to remote audience. In some other cases such as surveillance, the operator may be able to watch any of the cameras A/V stream by switching from one camera to another, but the operator cannot have a continuous view the scene in the areas where the views of different cameras overlap.

One obvious and commonly deployed solution is to use cameras that can rotate across one or more axis. The audience or camera man can rotate the camera and watch any area of the scene that he/she wants to see. However there are drawbacks to this method. First, a moving camera is a mechanical system and therefore prone to failure. Second, rotating camera is due to its mechanical nature, and generally it is not possible to quickly change to a desired view. Third, a rotating camera creates a limitation where there will be only a single common view for all audiences/viewers and in cases where multiple users each requires to have his/her own dedicated view, the overhead of having dedicated camera(s) for each user will be high.

### SUMMARY OF THE INVENTION

This invention defines a framework, in which each remote audience is in full control of which area from the complete 360 degree (Azimuth and/or Elevation) coverage view of the scene to be watched at any time.

The idea is that multiple cameras are installed in a camera assembly, in such a way that when their views are combined they create an entire 360 degree view to the scene. The A/V output of cameras are transmitted to a computing/data center that stitches the A/V streams of the cameras and produces a complete Master View of the scene. A remote audience can use a remote control device to communicate to the data center and move his/her own viewing field and watch any desired part of the Master View or digitally zoom to any area. The effect is that the audience's viewing experience is much closer to the viewing experience of a person sitting and watching the event at the event location, which can turn his/her head (left, right, up, or down) and watch any part of the event space as desired at any time.

### BRIEF DESCRIPTION OF THE DRAWINGS

FIG. 1 is a schematic diagram of the functional model of one of the functions performed in the Event site

FIG. 2 is a schematic diagram of the functional model of one of the three main functions of the functions performed in the Data Center.

FIG. 3 is a schematic diagram of the functional model of one of the three main functions of the functions performed in the Customer site.

FIG. 4(a) shows the local coordinate frame of reference (X1, Y1) for a camera

FIG. 4(b) s an arbitrary point P (xᵢ, yⱼ) in the camera's local coordinate frame that represents an arbitrary pixel in the camera's image frame.

FIG. 5 shows the Image frame of all cameras in a camera assembly comprising of 8 cameras.

FIG. 6 shows the Local coordinates of all cameras in a camera assembly.

FIG. 7 shows the transformation of the cameras' local coordinate system (Xi, Yj) to a Global Coordinate System (X, Y).

FIG. 8 shows the Master Stream view and customer view in their matrix forms.

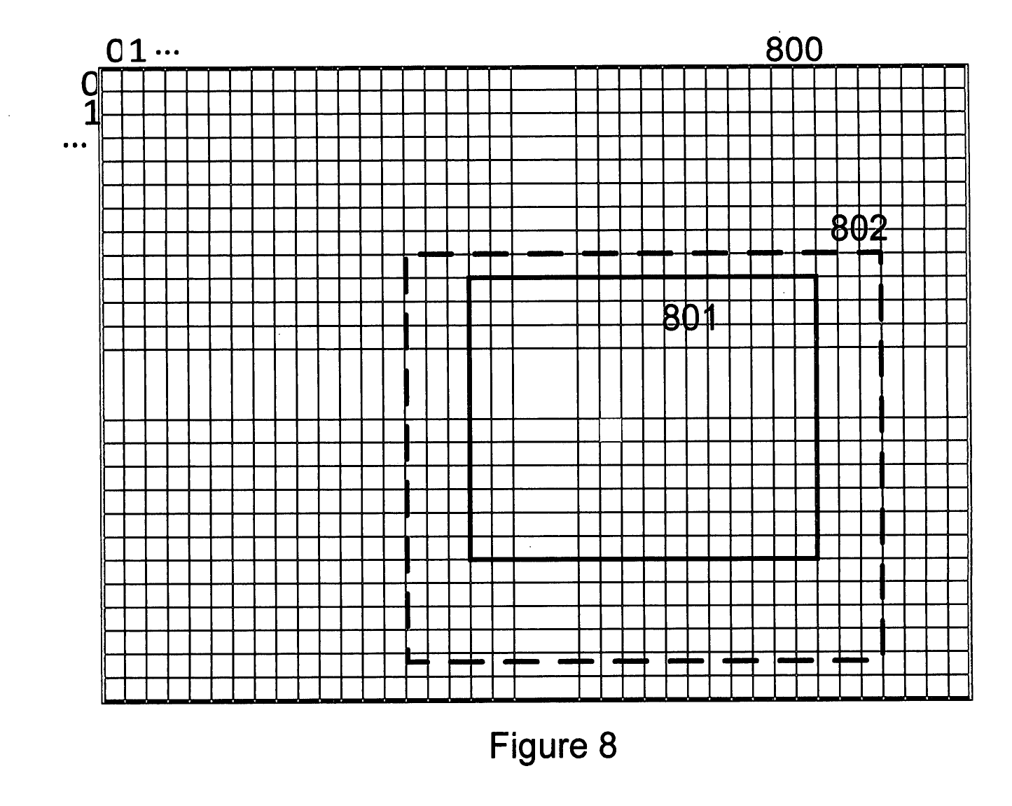

FIG. 9(a) shows the view field of two adjacent cameras that have some overlap

FIG. 9(b) shows the schematic diagram of the overlapping area of two adjacent cameras with their corresponding skew.

FIG. 10 is the schematic diagram of the overlapping area of two adjacent cameras after de-skewing.

FIG. 11 is the schematic diagram of a possible physical implementation at the source of the AUDIO/VIDEO streams located at the event site.

FIG. 12 is the schematic diagram of a possible physical implementation at the computing/data center.

FIG. 13 is the schematic diagram of a camera assembly, comprising of 8 cameras installed on circular surface.

FIG. 14 is the schematic diagram of a camera assembly comprising of cameras installed on horizontal and vertical planes.

### DETAILED DESCRIPTION OF THE PREFERRED

### Functional Model

There are many functional elements that have to work together to create the desire user experience, who is viewing a live event remotely, while being able to watch any part of the event space at any time.

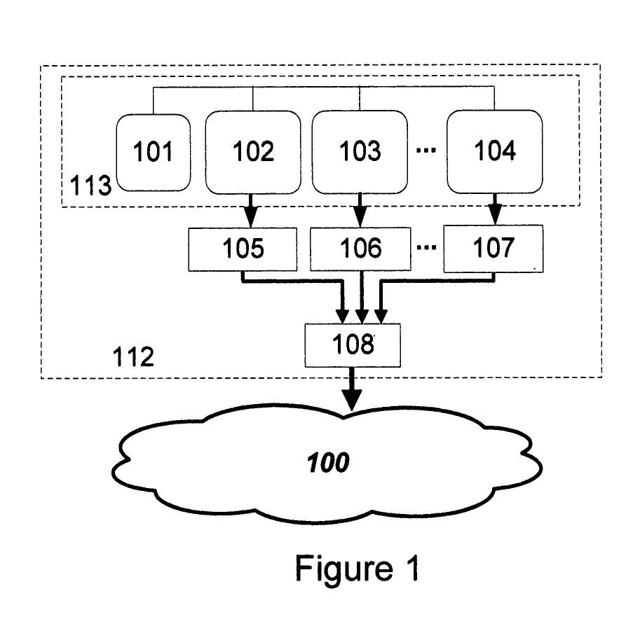

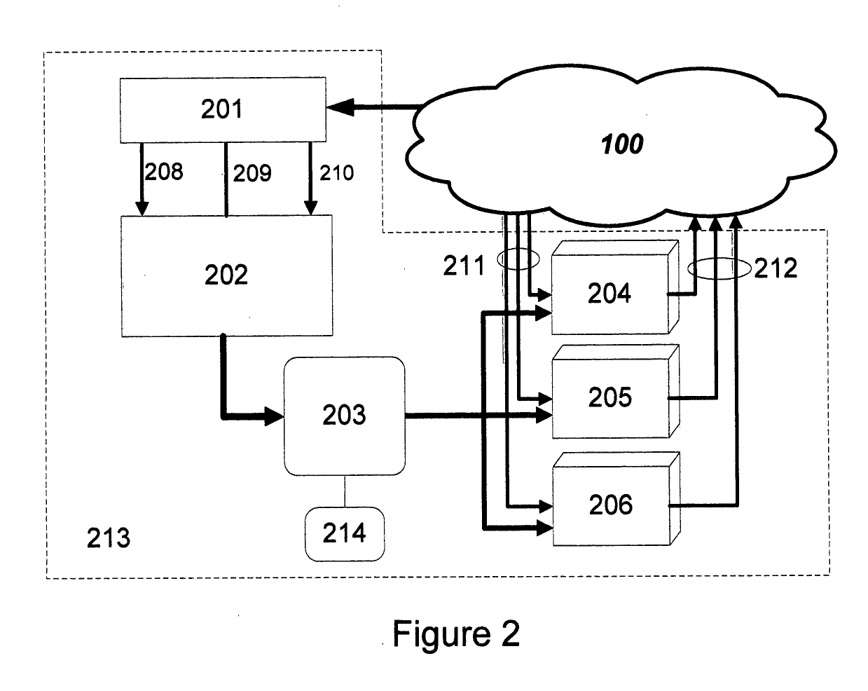

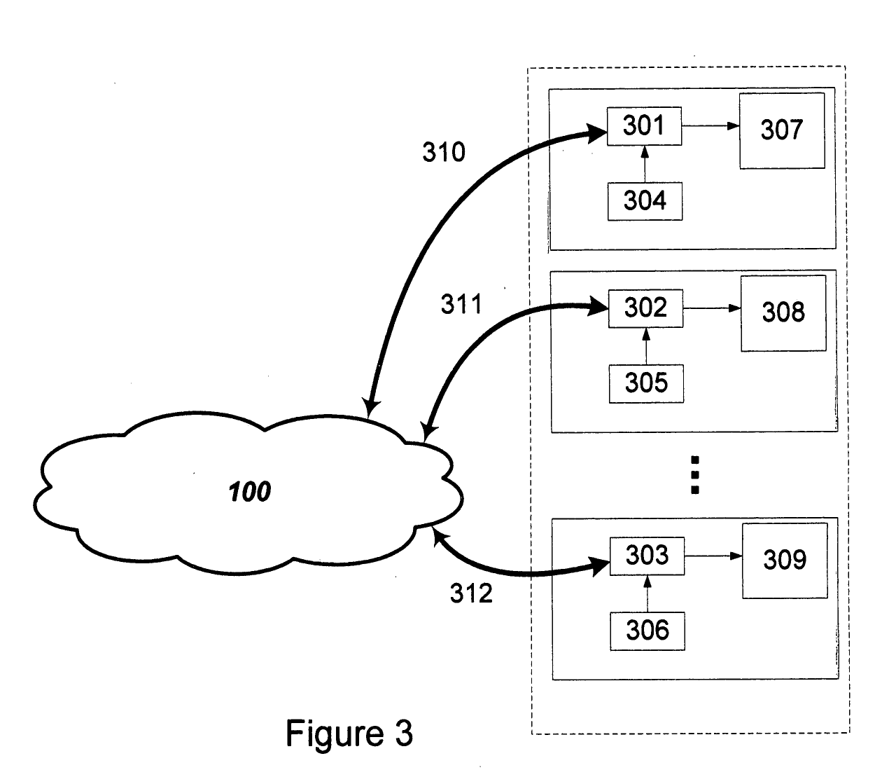

In one embodiment, the functional model comprises of 3 major functions:
1. Event site functions (FIG. 1)
2. Data center functions (FIG. 2)
3. User site functions (FIG. 3)

FIG. 1 shows one example of the Event site (112) along with its detail functional elements. In this example, there are a number of cameras (102, 103 . . . 104) that record the live event and generate AUDIO/VIDEO streams. These cameras are optionally synchronized to each other via a Sync line (101), in such a way that their frames are synchronized in time domain. The AUDIO/VIDEO output of each camera is optionally encoded and compressed (105, 106 . . . 107) and the result is then multiplexed via a Multiplexing function (108) and the result is then forwarded to the Data center via a Network (100), which could be the Internet or a dedicated private network or even a Point-to-point link.

FIG. 2 shows one example of the processing/data center along with its detail functional elements. In this example the multiplexed AUDIO/VIDEO streams are received from the Network (200). A de-multiplexer (201) de-multiplexes decodes the AUDIO/VIDEO signal and recovers the AUDIO/VIDEO stream of each camera (208, 209 . . . 210). Then a Stream Stitching Function (202) stitches all streams together to create a Master Stream View (203) that covers the whole viewable area of the event space. Each end user is assigned a Virtual Machine or VM (204, 205 . . . 206) in the Data Center. Virtual Machines get their command (211) remotely from remote users via the network (200). The VMs then select the proper frame out of the Master Stream View based on the received commands and creates a User Adaptive AUDIO/VIDEO stream (212) for each user. The User Adaptive AUDIO/VIDEO stream may be compressed and encoded before being transmitted to the user.

FIG. 3 shows one example of the User site that comprises of
Audio/video display (307, 308 . . . 309) such as computer screen, TV, Smart phone, Table, Virtual reality goggle, etc.
Set-top box (301, 302 . . . 303) such as XBOX, PLAY STATION, APPLE TV, ROKU, Wii, etc.)
Remote controller (304, 305 . . . 306) such as a set-top-box remote control, motion sensor, etc.

In an embodiment of the invention, the user uses a remote controller (304, 305 . . . 306) to scroll the video image on the screen to right, left, up or down. The remote control signal is transmitted to the data center, and the Virtual Machine assigned to the customer in the data center creates the desired customer view from the Master View and sends the user adaptive AUDIO/VIDEO stream (310, 311 . . . 312) to the user. The set-top box (301, 302 . . . 303) is in charge of receiving the AUDIO/VIDEO stream and displaying it on the screen (307, 308 . . . 309).

### Audio/Video Source (Cameras)

The first functional element is a series of N cameras (102, 103, . . . 104), In one embodiment these cameras are in a camera assembly (113) that combined together are able to capture the complete 360 degree field of view or any wide angle view of the field. In one embodiment the cameras cover 360 degrees of Azimuth and 360 degree of Elevation.

In another embodiment less coverage may be needed. For example in many sporting events 360 degree Elevation view may not be required. The idea is to stitch the view field of the cameras to each other to recreate a Master view. The video cameras can be of any type. However for best result High-Definition (HD) and possibly 3D cameras are preferred.

### Synchronization

It is required to synchronize the frame timing in all cameras. In one embodiment this can be done by physically connecting a Synchronization line (101) to all cameras from a clock source (such as GPS, AV switch, AV mixer, etc.).

In another embodiment it is also possible to synchronize the frame timing in post video processing by software or firmware, but it is computationally very intensive and physical synchronization is preferred.

### Compression/Encoding

The output of N cameras (102, 103 . . . 104) is N×AUDIO/VIDEO streams. In one embodiment these AUDIO/VIDEO streams may be RAW format and may be encoded and compressed (105, 106 . . . 107) via one of the available coding techniques such as H.264/MPEG-4, MPEG-2000, etc.

In another embodiment these AUDIO/VIDEO streams may be encoded and compressed inside the cameras without need for external encoding/compression.

In one embodiment the compressed and encoded AUDIO/VIDEO streams is Multiplexed (108) and sent to the Data Centre (213).

In another embodiment each AUDIO/VIDEO stream is transported separately to the data center without multio0lexing with other AUDIO/VIDEO streams.

In one embodiment where all cameras do not have the same frame rate, which can be due to the usage of different types of cameras in the Camera Assembly, some cameras may have a higher frame rate than others. The data rate of each camera is represented by timing transformation (t)

In one embodiment the timing transformation (t) may be sent to the data center (213). This information is used to synchronize matching frames from different camera at each moment.

In another embodiment the data center processing computes the timing transformation (t) by processing and comparing the AUDIO/VIDEO streams.

### Decompression/Decoding

In one embodiment when the Multiplexed and possibly encoded AUDIO/VIDEO streams are received in the Data Center (213), the streams are de-multiplexed in a de-multiplexer (201) and if needed are decoded/decompressed to their original RAW AUDIO/VIDEO format (208, 209 . . . 210). This would allow simpler Audio/Video processing on the AUDIO/VIDEO streams.

In another embodiment the compressed and encoded AUDIO/VIDEO streams may be used directly for further Audio/Video processing but would require very complex algorithms.

In another embodiment the AUDIO/VIDEO streams may be received individually and therefore no de-multiplexing is required.

In another embodiment the AUDIO/VIDEO streams may be received in Raw format and therefore no de-coding is required.

### Stream Stitching

In one embodiment, the demultiplexed AUDIO/VIDEO streams (208, 209 . . . 210) are sent to a Stream Stitching function (202). The job of the Stream Stitching (202) is to recreate the whole original view space by properly stitching the AUDIO/VIDEO streams (208, 209 . . . 210) based on their “T” Transformation function. The result is a Master Stream View or MSV (203).

The following formula shows the overall logic used to create the MSV. In this formula “U” is the Union function and “∩” is the Intersection as defined in Set Theory:

MSV=[Cam#1UCam#2UCam#3 . . . UCam#N]−[Cam#1∩Cam#2∩Cam#3 . . . ∩Cam #N]

In one embodiment the MSV may be temporarily or permanently stored in Memory, Cache or Hard drive (214).

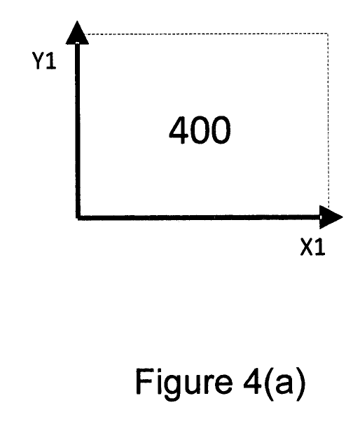

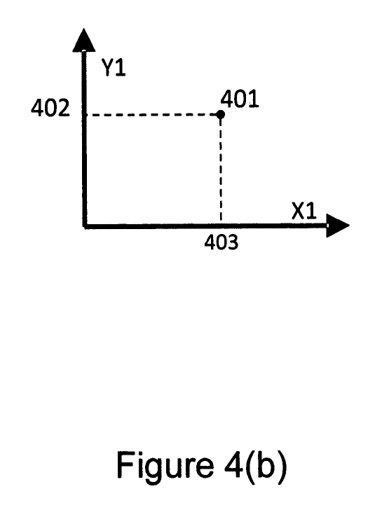

FIG. 4(a) shows an example of the image frame (400) of a single camera and the local coordinate frame (X1, Y1) that is attached to the camera's image frame. FIG. 4(b) shows an example of an arbitrary point (401), with local coordinates of (403, 402) that represents a pixel in the camera's image frame.

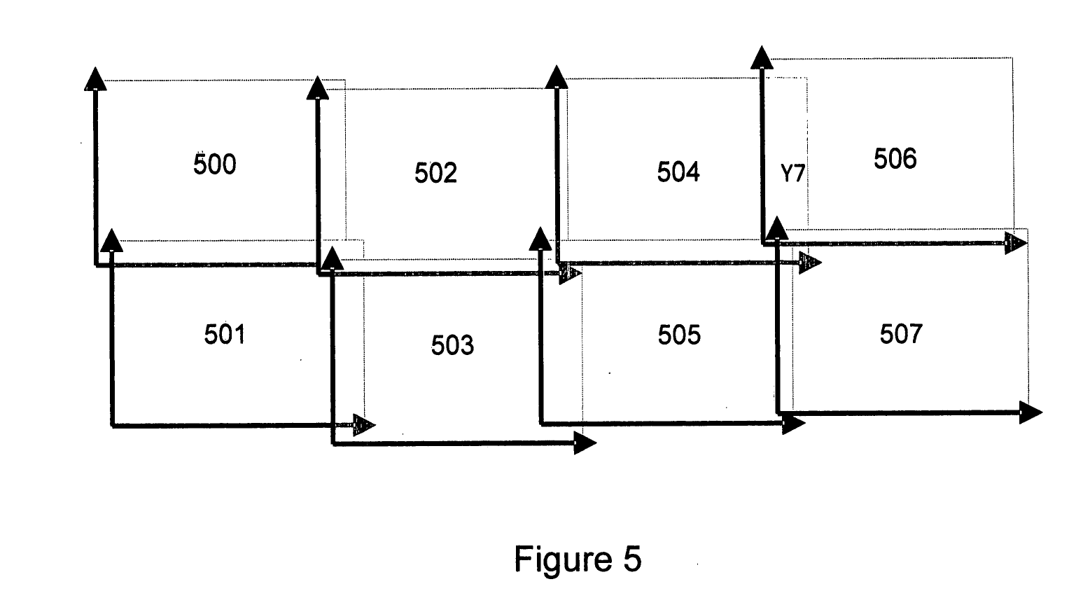

FIG. 5 shows an example of a Camera Assembly consisting of eight cameras. The image frames of the cameras overlap and each camera has its own local coordinate frame (500 to 507). Since the cameras are mechanically connected to the assembly, there is no guaranty that all cameras' coordinate frames will perfectly align and generally that may not be the case.

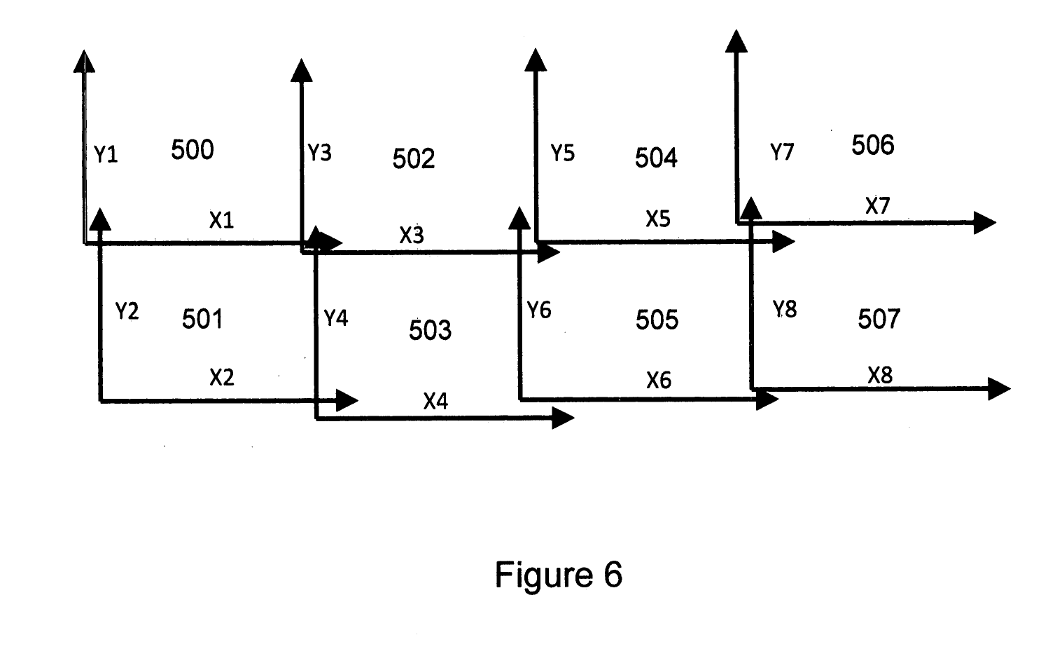

FIG. 6 shows an example of local coordinate frames of 8 cameras, where the camera's coordinate frames (500 to 507) are not perfectly aligned.

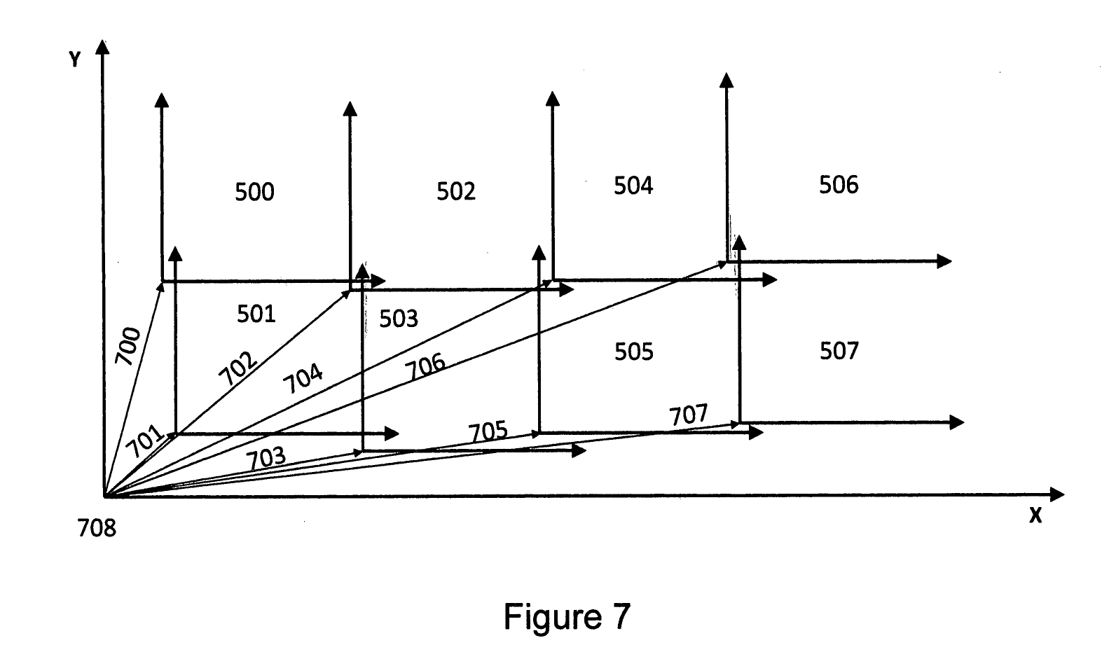

FIG. 7 shows an example Of the Transformation vector (700 to 707) of the cameras' local coordinate system (500 to 507) to the Global Coordinate System (708).

An arbitrary point P(xᵢ,yⱼ)ₙ in a camera's local coordinate system can be translated to a corresponding point in the Global Coordinate System P(v, w)_{XY} using the following formula, where Tₙ is the transformation Matrix for camera number “n”:

P(v,w)_{XY}=Tₙ×P(xᵢ,yⱼ)ₙ

For example for camera 3 the arbitrary point P(xᵢ, yᵢ)₃ will be translated to the Global coordinate using the following formula, where T₃ is the Transformation matrix for the 3rd camera:

P(v,w)_{XY}=T₃×P(xᵢ,yⱼ)₃

The Transformation (Tₙ) of cameras local coordinate systems P(xᵢ,yⱼ)ₙ to the camera assembly Global Coordinate System P(v,w)_{XY} is fixed as long as the cameras do not move relative to each other.

In one embodiment the Transformations values of the cameras can be transmitted to data center along with the image information.

In another embodiment the software/firmware in the data center can compute the Transformation functions. Using this approach the coordinates of all image pixels of the cameras can be translated to the pixel coordinates in the Global Coordinate Frame/System. This calculation takes place at the data center and the resulting image/frame is called Master Stream View.

In one embodiment, in places where the views of two cameras overlaps, software can basically search in the 2D image space of the overlapping area and detect the overlap and compensate for the errors in the cameras transformation values. This will ensure a seamless Master Stream View.

### Transformation

The stream of images from the cameras can be either 2D or 3D. In one embodiment the transformation that will be applied to the images can be the Affine transformations. For example in the 2D case the homogeneous form of the transformation could be:

$$( \begin{matrix}cos ∝ & - sin ∝ & {x}_{t} \\ sin ∝ & cos ∝ & {y}_{t} \\ 0 & 0 & 1\end{matrix} )$$

Where ∝ is the angle of rotation and Xₜ and yₜ are the translations along the X and Y axis, respectively. An example of the transformation for 3D case is:

$$\begin{matrix}( \begin{matrix}cos ∝ cos β & cos ∝ sin βsin γ - sin ∝ cos γ & cos ∝ sin βcos γ + sin ∝ sin γ & {x}_{t} \\ sin ∝ cos β & sin ∝ sin βsinγ + cos ∝ cos γ & sin ∝ sin βcos γ - cos ∝ sin γ & {y}_{t} \\ - sin β & cos βsin γ & cos βcos γ & {z}_{t}\end{matrix} ) \\ \begin{matrix}0 & 0 & 0 & 1\end{matrix}\end{matrix}$$

### Determining Cameras Transformation Functions

One of the steps to set up the camera assembly is determining each camera's Transformation Function based on the position of the camera relative to other cameras in the assembly to create a global coordinate system for all cameras. For this purpose, a software tool will be used to help the human operator to determine the Transformation Functions by going through a step by step procedure.

The first step is to prepare a pattern of dots on, for example, a sheet of cardboard where the dots are numbered. This board is called the Setup Pattern.

The size of the Setup Pattern and distance among the dots should be in such a way that when the Setup Pattern is placed in front of the cameras, the dots are spread on the camera image as oppose to being condensed in one location. This will insure more accurate results.

The Setup Pattern will be placed in a location that at least two camera can see it. For example, it is placed in the overlap area of two adjacent cameras. Next the operator runs a software tool, which receives the camera number in the assembly and shows the Setup Pattern seen from that camera on a computer monitor and the operator using a mouse points the cursor to a dot at a time according to their numbers and clicks on them. Without touching or moving the Setup Pattern, this will also be repeated for the other camera. The angle between the cameras will also be entered as another parameter. This angle will be enforced by the structure of the assembly. This process will be repeated for all cameras in the assembly.

Then the software tool will calculate a linear transformation that transforms the dots from each camera to a global coordinate system by combining the linear transformation between each two adjacent cameras local transformations, which was directly calculated from the difference between the X and Y coordinates of a dot seen in two adjacent cameras.

### Camera Frame and Coordinate Calibration

The cameras in a camera assembly need to have some overlap (900) in the X and/or Y axis, so that continuous coverage in X and/or Y plane is guaranteed without any gap. On the other hand it is physically almost impossible to perfectly align the cameras in the X and Y axis. In one embodiment, one of the functions of Data Center processing is to calibrate the cameras in a camera assembly in both X and Y axis. The result of the calibration would be the Transformation function (T) per camera.

In one embodiment the calibration can be done statically, meaning taking one frame of all N cameras at some time (t) and trying to align them vertically and horizontally. This can usually be done in the preparation phase before the actual filming of the event starts.

In another embodiment the calibration can also be done dynamically, meaning that every “τ” seconds the software can perform calibration of all N cameras in the background and compute the new “T” function for all cameras and then apply it to all future frames, until the result of a new calibration is available. Dynamic calibration is useful when camera movement is possible such as in high-wind situations.

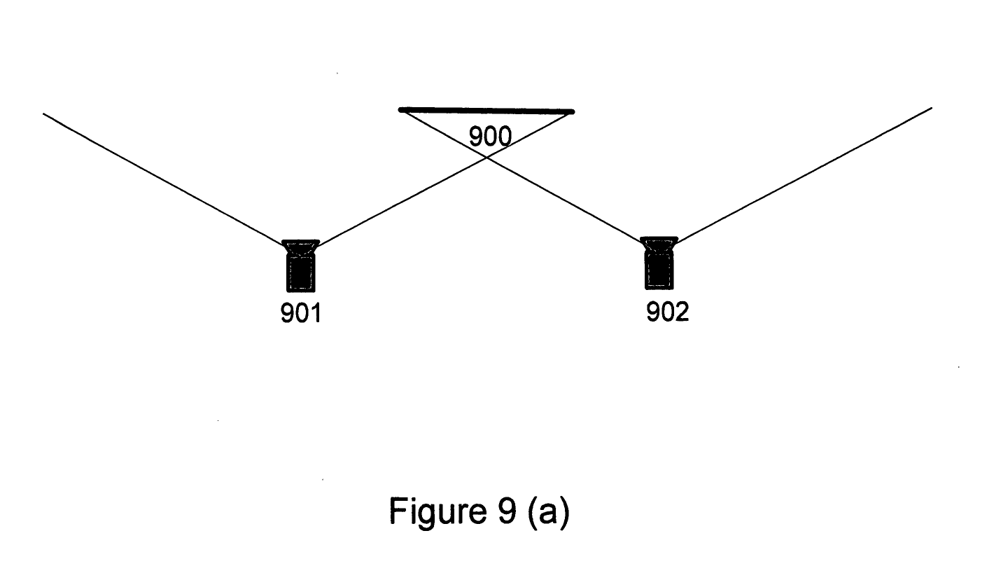

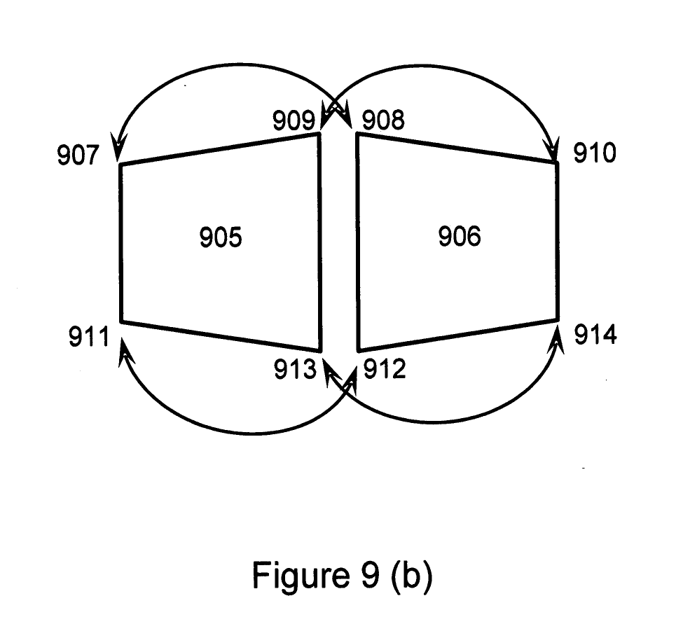

In one embodiment the overlapping areas between the adjacent cameras (900) can also be used for correcting the optical distortion of the cameras at their peripheral areas view. For example for two adjacent cameras (901, 902) that are installed on a horizontal line, the overlapping image of the left camera (905) will be slightly skewed to the right and the similarly the same overlapping image of the right camera (906) will be slightly skewed to left as shown in FIG. 9(b). In this figure, the arrows show corresponding points in the overlapped area. They show how the left side of the overlapped image (907, 911) is compressed for the left camera while the same area is stretched for the right camera (908, 912) and similarly for the right side of the overlapped image (910, 914) is compressed for the right camera while the same area is stretched for the left camera (909, 913).

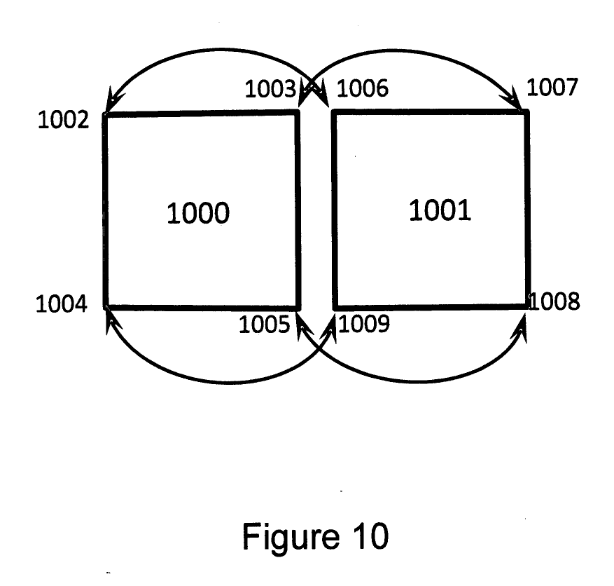

In one embodiment the difference in the overlapping area (900) between two images can be used to find a linear transformation that converts both skewed views to overlapping images that look the same and this transformation will be applied to peripheral areas and smoothed out as the pixel getting closer to the center view area to get a smoothed linear image among all cameras. FIG. 10 shows an example of the overlapped area of the two adjacent cameras (1000, 1001) after transformation, which are of similar size and shape. In this example point (1002, 1004) in left camera correspond to point (1006, 1009) of the right camera. Similarly point (1003, 1005), in left camera correspond to point (1007, 1008) of the right camera.

### Contrast, Brightness and Color Calibration

In addition to compensating for small X and Y errors in the cameras transformation values, the overlapping areas (900) of adjacent cameras (901, 902) could play important roles in calibrating the Contrast, Brightness and Color of the adjacent cameras.

In one embodiment, once the corresponding pixels in the overlapping areas between cameras are detected using software search techniques, the calibration process at the data center can detect differences between the Contrast, Brightness and Color values of the two camera pixels corresponding to a single point in the view and since both cameras should see the same value the differences in the values will be as a result of differences in the cameras characteristics.

The policy of the calibration program/process to correct the difference can be based on different methods. In one embodiment, one camera can be identified as the reference camera and the other camera can adjust its Contrast, Brightness and Color values to match the values of the reference camera. In another embodiment both cameras change their Contrast, Brightness and Color values to meet at the middle/average of difference between cameras.

In one embodiment, the calibration process may start from one side of the Master view and proceed to the other end. For example the process can start from the cameras that make the left side of the master view and continue to the right side or start from the top and continue to the bottom of the view. In another embodiment, every round of calibrating the Contrast, Brightness and Color starts from a different side so the average values converge to a stable average value.

In one embodiment, the calibration process can be performed periodically and the calculated Contrast, Brightness and Color values for each camera can be applied to the received frames/images to correct their Contrast, Brightness and Color. In another embodiment the calculated Contrast, Brightness and Color values can be send back from the data center to each camera so that the cameras can adjust themselves accordingly in real time.

### View Commander and Interactive Set Top Box

In one embodiment a user can use a computer/tablet/smart phone to select and stream the desired customer view (801) from a Master view (800) to the screen (307, 308 . . . 309).

In another embodiment a larger view (802) than the desired customer view (801) is sent to the customer from the data center. Doing so could compensate for the delay between customer request and changing of the customer view. Since the extra information (801-802∩801) is available at the customer site at any point in time with zero delay.

In another embodiment an interactive set top box such as XBOX, Play Station, Wii, RAKU, Apple TV, etc. (e.g., 301, 302 . . . 303) can be used to select and stream the desired portion of the Master View (e.g., 801) to the screen.

In one embodiment, the user can use a view commander (e.g., 304, 305 . . . 306) such as a remote control device with motion sensor or using buttons on the remote control arrows or use a Virtual Reality goggle with motion sensor, orientation and position sensor, etc. to send commands to the Data Center (213) to change the received adaptive AUDIO/VIDEO stream (211) to view a different portion of the Master View. The effect is similar to scrolling the video to left, right, up and down smoothly. Any portion of the entire event field of view (master view) can be viewed at any time.

In one embodiment the user may zoom-in or zoom-out any view by pressing a button or performing a specific motion on the remote control device.

In one embodiment, a user may use on screen menu provided by the Set-top box or any key on the remote commander to request extra information alongside the received AUDIO/VIDEO stream. The extra information could be anything such as the score board, statistics, details about the event, history of a team or player, etc.

### Virtual Machine

In one embodiment, each user, after logging in, is assigned a Virtual Machine or VM (204, 205 . . . 206) on the servers in the Data Center. VMs are virtual processors that run on physical servers. A server can support tens or hundreds of VMs. The job of the VM is to create the unique individualize adaptive user view required by user and then compress/decode it if necessary and send it to the user. The VM reacts to the user commands coming from view commander, by changing the transmitted stream such that the effect is similar to scrolling or turning the head left, right, up or down.

In another embodiment a complete server or computer can be assigned to a user.

In one embodiment upon customer request, the VMs can also send extra information alongside the AUDIO/VIDEO stream to the user. The extra information could be anything such as the score board, statistics, details about the event, history of a team or player, etc.

### Physical Implementation

This section describes one example of the possible physical implementation of the technology. Note that there may be other ways of implementing this technology. An example of a physical implementation is shown in FIG. 9, and FIG. 10.

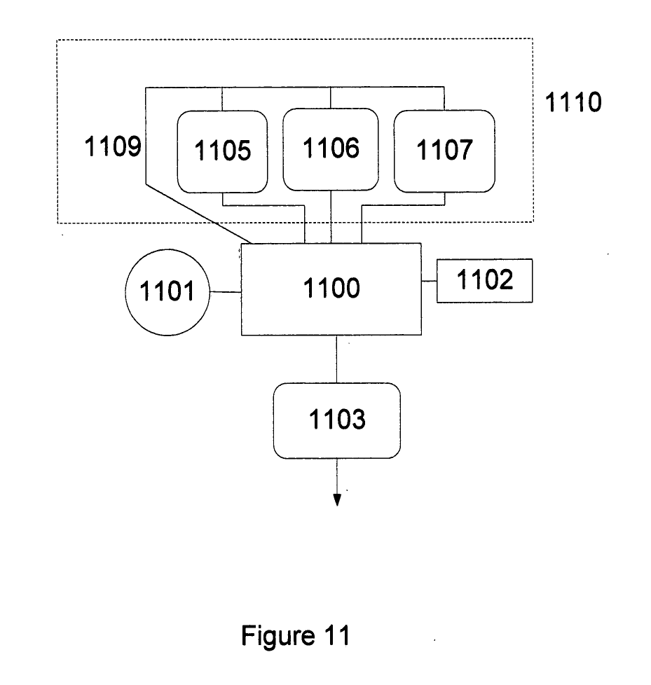

FIG. 11 shows an example of physical implementation at the source of AUDIO/VIDEO, which is primarily at the event location. At the AUDIO/VIDEO source, multiple cameras (1105, 1106 . . . 1107) in a camera assembly (1110) are connected to an AUDIO/VIDEO switch (1100). The AUDIO/VIDEO switch encodes and multiplexes the multiple cameras. It also has a synchronization line (1109) to all cameras to synchronize their frames in time domain. The encoded audio/video is then transmitted to a Data center via a switch/router (1103).

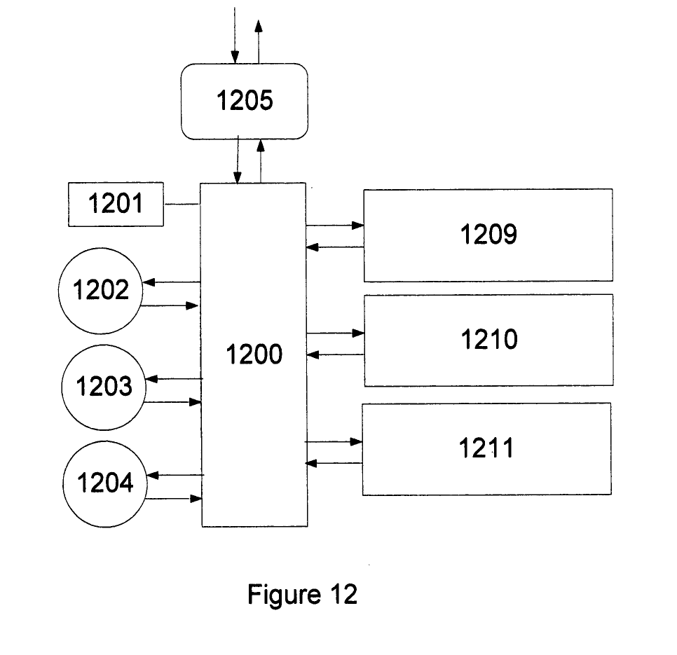

FIG. 12 shows an example of a possible implementation at the Data Center. At the Data Center, Switch/Router (1205) terminates the Transport Tunnel or connection and delivers the AUDIO/VIDEO stream to the server (1200). The server may store the received AUDIO/VIDEO streams in local storage (1202). The server then decodes the AUDIO/VIDEO streams either purely by software or with the help of a graphic card (1209) and may store the result also in local storage (1203). Then the server performs the required stitching function in software or with the help of a graphic card (1210) to create the Master view and may store the result in local storage (1204). Either the same server or a different server creates a personalized view based on customer commands. The personalized view is created from the Master View by software or with the help of a graphic card (1211) and then is played out for the customer by server (1200).

### Camera Assembly

A series of N cameras are required to capture the required live field of view. In one embodiment, the cameras are fixed and don't move.

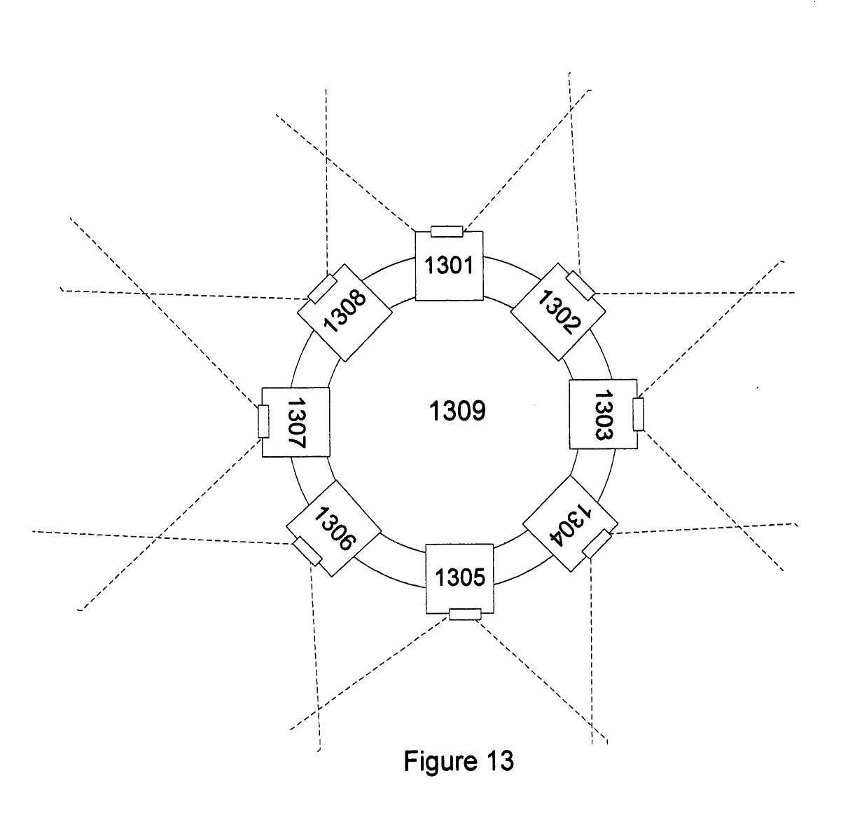

In an embodiment, the cameras (1301 to 1308) are vertically aligned as much as possible to reduce or eliminate frame calibration, which is required in a later stage. This can be done for example by installing the cameras on a circular plate (1309) as shown in FIG. 13.

In one embodiment, the cameras are spread evenly in the 360 degree of the circular plate.

In an embodiment, the amount of overlap between cameras is kept to a minimum (but not zero since some overlap is required for calibration) to reduce the number of cameras required.

Each camera covers an angle of view of (a) as shown in (1310). The angle of view depends on the focal length of the lens (d) and the size of the Camera's sensor (L). The formula is:

α=2×ArcTang(d/2f)

For example a 35 mm camera with a 40 mm lens will have α=48 Degrees.

The number of cameras required depends on the angle of view of each camera. For example when angle of view is 48 degrees the number of cameras required to cover the 360 degree view is 360/48=7.5, which means 8 cameras are required.

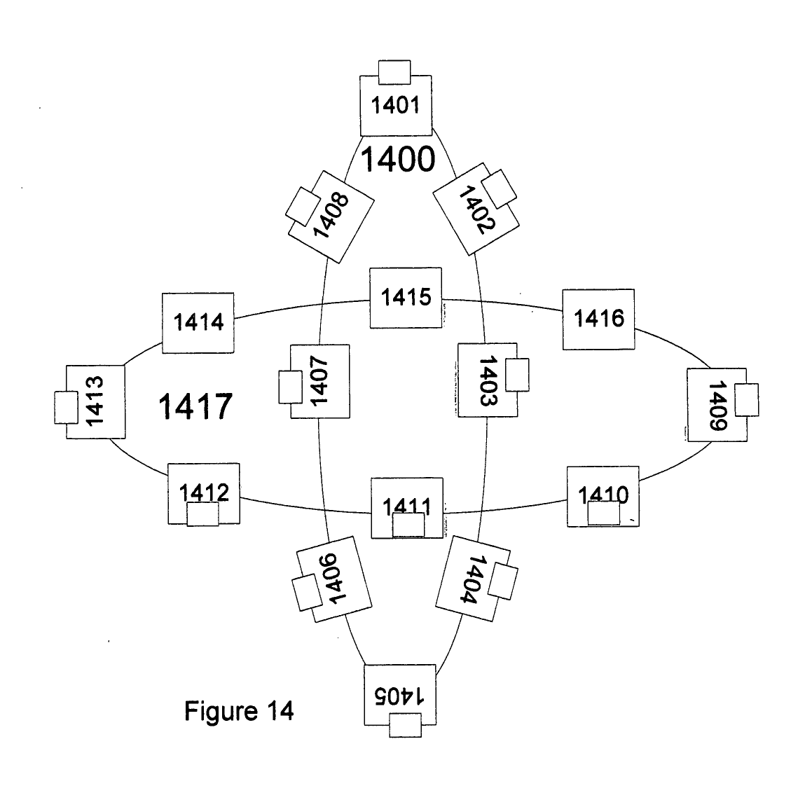

In case complete 360 degree Azimuth coverage is required, the cameras can be installed on a horizontal circular plane on different Longitudes. In case 360 degree Elevation view is also needed, then cameras can be installed on a vertical plane on different Latitudes of a sphere. In case full 100% coverage of the space is required then cameras may be installed on a logical sphere so that full coverage is achieved. Example of cameras installed on Horizontal and Vertical plane is shown in FIG. 14, where cameras (1401 to 1408) are installed in the vertical plane (1400) and cameras (1409 to 1416) are installed in the horizontal plane (1417).

In one embodiment, more than one camera assembly may be used and placed at different locations around the event area.

In one embodiment sufficient camera assemblies are installed at pre-calculated locations to create a continuous circular view of the event from all angles with no gap. The effect is like someone watching the event and moving around the event location to view the scene from different point of views.

### Audio/Video Multiplexer & Router

The Cameras are connected to an AUDIO/VIDEO Multiplexer (AUDIO/VIDEO Mux) such as the one shown in (1100).

In one embodiment the AUDIO/VIDEO Mux performs the Compression/Coding of the AUDIO/VIDEO streams and then Multiplexes the result and sends it to the Cloud (Data Center), via any available connection such as PON, Direct Ethernet Fiber, WiFi, WiMAX, LTE 4G, SONET/SDH, etc. The compression and coding may be done in software or with the used of graphic cards such as the one shown in (1102).

In one embodiment the AUDIO/VIDEO multiplexer may also store the Raw or Encoded AUDIO/VIDEO streams in a local storage such as the one shown in (1101).

In another embodiment, the AUDIO/VIDEO Mux sends out a Time Synchronization signal to all cameras so that the frames produced by all cameras are synched in time. Doing so would greatly reduce the complexity of the AUDIO/VIDEO processing that is required.

In one embodiment the AUDIO/VIDEO Mux may be a specially designed hardware and software or may simply be a computer or a collection of computers.

### Local Storage

There may be a local storage in the form of memory, Flash or even hard drive. The job of the local storage can be to act as buffer in case the Internet/cloud connection speed goes down or in case the connection to the cloud of data center is lost. The local storage may also be used as temporary or permanent backup.

Examples of local storage are shown in 1101, 1202, 1203, 1204.

### Switch/Router

The job of switch/router is to terminate the Transport and Tunneling protocols and deliver the AUDIO/VIDEO stream to the Server (1200). One example of switch/router is shown in (1205)

### Server

Server is a high-end computer which may have multiple CPU cores. In one embodiment the server can run some sort of virtualization software such as Hypervisor®. The server implements many Virtual Machines (VMs) that are assigned per customer.

Server controls the whole AUDIO/VIDEO processing in the Data Center. An example of a server is shown in (1200).

Video Card/Video processor

Each Server may have one or more Video card or video processors in order to provide HW acceleration to the server's CPU.

In one embodiment the Graphic cards or processors have their own GPUs that are very powerful and specially designed for graphics. The Graphic cards or processors can be used by VMs to perform decoding, stitching, scrolling and encoding the AUDIO/VIDEO streams.

In one embodiment, the video cards are virtualized so that multiple VMs can use them simultaneously.

In another embodiment, the video processing is done purely in the server software, if powerful CPUs and enough memory are available.

### Sequence of Events

This section describes example of the sequence of events in a typical implementation.
1. One or more Camera assemblies are installed at pre-determined locations before the live event starts.
2. Cameras are attached to an AUDIO/VIDEO Multiplexer to encode and multiplex the AUDIO/VIDEO streams and to synchronize the cameras
3. The AUDIO/VIDEO Multiplexer is attached to a Switch/Router for transmission to a data center.
4. AUDIO/VIDEO streams are simultaneously stored in Local storage for temporary backup
5. The AUDIO/VIDEO streams are transmitted to the data center
6. AUDIO/VIDEO streams are demultiplexed and decoded and stored in Data Center storage
7. A snap shot of all cameras at a particular instant in time is used to perform X, Y, Contrast, Brightness and Color calibration
8. The AUDIO/VIDEO streams are stitched to create a Master View
9. A subset of the Master view is transmitted to customer as default view
10. Each customer is assigned a Virtual Machine (VM) in the data center
11. Customer uses a remote control device to move the displayed view to other areas of the Master view or to zoom to a specific area.
12. The VM receives command from a customer remote commander and creates new customer adaptive view based on received command
13. The customer view AUDIO/VIDEO stream is streamed and transmitted to the customer site, and the set-top box at the customer site displays the customer AUDIO/VIDEO stream on the display.

### 1.1 Applications

There are many application for the technology mentioned in this invention. A few of them are listed below.

1. Sports and Concert events live broadcast

2. Surveillance

3. Remote surgery

4. Plane surveillance camera system

5. 360 degree view for Cars

6. Remote piloting

7. Remote driving of vehicles

8. Robots

9. Unmanned rovers

10. Online chats/Video Conferencing

### Benefits

Following is a list of some of the benefits of using the technology described in this invention.

1. Can provide full 360 Degree coverage in Azimuth and Elevation, which represents the complete possible live field of view. This is useful since no action in the entire event will be missed.
2. Each user can control which part of the complete live field of view; he/she wants to see at any point in time regardless of where the action is (such as where the ball is in a sport event). The user thus feels that he/she is sitting and watching the event live.
3. If similar camera assemblies are installed in different locations at the event, each user can even change his/her entire point of view at any time
4. User can selectively zoom in/out to any area of the viewable scene
5. No need for a camera man to be at the camera site
6. No need for moving/rotating the camera during the entire event
7. All AUDIO/VIDEO processing can be done in the Cloud (Data center) and therefore reducing the cost to the broadcaster.
8. Extra Augmented Reality information (Such as the score board, statistics board, etc.) can be requested by a user to be displayed alongside the live Audio/Video.

### Invention Features

This invention incorporates the following features.
1. A method for creating multiple streams of Audio and Video (AUDIO/VIDEO stream) from multiple cameras are combined to create a 360 degree view in Azimuth and/or Elevation and/or different point of view.
2. The cameras have overlap in horizontal and/or vertical axis
3. The Cameras are Hi-Definition (HD) and/or 3D
4. Multiple Camera assemblies are placed at different locations to cover an event from different point of views
5. Multiple AUDIO/VIDEO streams are stored locally and/or transmitted to a data center either as RAW or compressed data
6. Multiple AUDIO/VIDEO streams are encoded and compressed before transmission
7. Multiple AUDIO/VIDEO streams are multiplexed before transmission, using software or graphic cards or using an Audio/Video Multiplexer (AUDIO/VIDEO Mux)
8. Multiple AUDIO/VIDEO streams are transmitted via Ethernet, EPON, GPON, WiFi, SONET/SDH, OTN, Satellite, etc to the Data Center over a dedicated network or over the Internet.
9. Receiving the AUDIO/VIDEO stream in Data Center, terminating the Transport and delivering the multiplexed AUDIO/VIDEO stream to one or more servers
10. Received multiplexed and encoded AUDIO/VIDEO stream are stored in a storage device such as memory or hard drive in the Data Center
11. Multiple AUDIO/VIDEO streams are demultiplexed using a software or hardware such s graphic cards.
12. Individual encoded AUDIO/VIDEO streams are stored in Data Center storage such as memory or hard drive
13. Individual AUDIO/VIDEO streams are decoded/decompressed and stored in a local storage such as memory or hard drive in the data center
14. Individual AUDIO/VIDEO streams stitched together to create the Master View
15. The resulting Master View is stored in a local storage such as memory or hard drive
16. Generating a default customer view from the Master view, based on a preconfigured algorithm or real-time control from the Video producer. The default view is created in such a way as to be suitable to the end user viewing device
17. A subset of the Master view (called adaptive view) is transmitted to each user based on the user command.
18. Receiving the adaptive AUDIO/VIDEO stream from Data Center and displaying it on TV, Projector, Computer, Tablet, Mobile phone or any type of screen using a computer or set-top box such as Wii, XBOX, Play station, Roku, etc.
19. User can change the default view using a remote control (called View commander), where the remote control has motion sensor and by moving the view commander the AUDIO/VIDEO stream smoothly scrolls to the desired direction or it has buttons and by pressing buttons the view commander the AUDIO/VIDEO stream smoothly scrolls to the desired direction, or where the set top box/console has motion sensor that detects movement of head, eye, hand or even brain signals and smoothly scrolls the view to the desired direction.
20. The view commander can be wearable gear such as a glass or glove
21. Receiving commands from a user at the Data Center and adjusting the AUDIO/VIDEO stream view based on the received commands
22. Encoding and transmitting the resulting adaptive AUDIO/VIDEO stream to the user
23. One or more Data Center servers or virtual servers could create the final adaptive AUDIO/VIDEO streams.
24. Each user could be assigned one or more Virtual Machines on the servers, where the Virtual Machines may use one or more graphic cards for hardware acceleration
25. Other information may be transmitted to the user such as the scoreboard, statistics, results of previous games, history of a player or a team, etc.
26. The video processing software or firmware calibrates the cameras in X or Y axis. The result is the X or Y coordinate of each camera's reference image frame
27. The X and Y coordinate of each camera's reference image frame are used to create the Transfer function (T) for that camera
28. The video processing software or firmware calibrates the cameras for Contrast, Brightness and Color.
29. One of the cameras could be assigned to be the reference camera and all cameras are calibrated to that camera.
30. The calibration is done based on average of the Contrast, Brightness and Color of 2 or more cameras.
31. The resulting calibration values may be transmitted back to each camera to adjust them in real-time or may be kept in local memory and used for software-based calibration.
32. The calibration may be done statically, once before the actual live camera shooting starts or dynamically and periodically in the background, during the actual live camera shooting and the result is applied to the future frames.

Any variations of the above teaching are also intended to be covered by this patent application.

1. A system capturing multiple discrete audio/video streams in a camera assembly and transmitting the said discrete audio/video streams to an audio/video server, said system comprising:
a camera assembly;
a local storage;
a audio/video encoder;
an audio/video multiplexer;
a switch/router;
a synchronization clock;
a data network; and
an audio/video server;
wherein said camera assembly comprising multiple video cameras, each producing a discrete audio/video stream;
wherein said video cameras are Standard Definition cameras or High Definition cameras;
wherein said video cameras are 2 dimensional cameras or 3 dimensional cameras;
wherein a first group of said video cameras are installed on a horizontal plane;
wherein a second group of said video cameras are installed on a vertical plane;
wherein said video cameras are synchronized via said synchronization clock;
wherein said discrete audio/video stream is in RAW format or is in encoded format;
wherein said discrete audio/video streams are multiplexed by said audio/video multiplexer to create an aggregate audio/video stream;
wherein said aggregate audio/video streams is transmitted to said audio/video server through said network via said switch/router.

2. The system as recited in claim 1, wherein said discrete audio/video streams are stored locally in said local storage.

3. The system as recited in claim 1, wherein said discrete audio/video streams are encoded by said audio/video encoder and multiplexed by said audio/video multiplexer to create said aggregate audio/video stream.

4. The system as recited in claim 1, wherein said video cameras receive commands from said data network and adjust their Contrast, Brightness and Color based on said received commands.

5. A system that combines multiple discrete audio/video streams and creates a panoramic Master view in real-time and streams a subset of the said Master view to user, said system comprising:
a computer server;
a local storage;
a audio/video decoder;
an audio/video encoder;
a audio/video de-multiplexer;
a video processing card;
a switch/router; and
a data network;
wherein said switch/router receives an aggregate audio/video stream from said data network;
wherein said audio/video de-multiplexer de-multiplexes said aggregate audio/video stream and recovers the comprising discrete audio/video streams;
wherein said audio/video decoder, decodes said discrete audio/video streams and creates RAW audio/video streams;
wherein said computer server calibrates the frames of said RAW audio/video streams in horizontal and vertical axis;
wherein said computer server splices said RAW audio/video streams to create a Master view;
wherein said computer server creates a user audio/video stream from said Master view for transmission to a user based on said user requested view;
where is said computer server changes said user audio/video stream based on commands received from said user over said data network;
wherein said computer server encodes said user audio/video stream and sends it to said user over said data network using said switch/router.

6. The system as recited in claim 5, wherein said discrete audio/video streams and/or said RAW audio/video streams and/or said user audio/video streams are stored in local storage.

7. The system as recited in claim 5, wherein said computer server uses said graphic card as hardware assist for said audio/video decoding, and said audio/video encoding.

8. The system as recited in claim 5, wherein said computer server uses said graphic card as hardware assist for said stitching operation.

9. The system as recited in claim 5, wherein said computer server calibrates said RAW audio/video streams in Contrast, Brightness and Color.

10. The system as recited in claim 5, wherein said computer server de-skews the overlap section of said RAW audio/video streams.

11. The system as recited in claim 5, wherein said computer server creates said user audio/video stream that corresponds to a wider view than the said user requested view, in order to offset the delay between said user and said computer server.

12. The system as recited in claim 5, wherein said discrete audio/video streams from 2 dimensional sources are combined to create 3 dimensional view.

13. The system as recited in claim 5, wherein said computer server sends augmented information to said user upon said user's request.

14. The system as recited in claim 9, wherein said computer servers sends results of said calibration of said RAW audio/video streams in Contrast, Brightness and Color to source of said discrete audio/video streams.

15. A system that sends a user request to change the received audio/video stream from a video server, said system comprising:
a set-top box;
a remote commander;
a display;
a data network; and
a switch/router;
wherein said set-top box receives user audio/video streams from said switch/router over said network;
wherein said set-top box displays said user audio/video stream over said display;
wherein said user sends user commands to said data network via said remote commander.

16. The system as recited in claim 14, wherein said set-top box is a computer or laptop or tablet or smart phone.

17. The system as recited in claim 14, wherein said remote commander is a remote control with button, or a remote control with motion sensor, or a sensor that senses head, eye, hand or other body part movements to detect said user commands.

18. The system as recited in claim 14, wherein said set-top box properly crops said user audio/video stream using a cropping window and creates a smaller display format for displaying over said display.

19. The system as recited in claim 14, wherein said user can send request to said data network to display augmented information on said display.

20. The system as recited in claim 18 wherein said set-top box can adjust said cropping window in response to said user commands.
